(19) United States
(12) Patent Application Publication
(10) Pub. No.: US 2010/0159836 A1
(43) Pub. Date: Jun. 24, 2010

(54) AUTOMATIC PRESENT TUNING USING RDS PROTOCOL

(76) Inventors: Francis Lau, Fremont, CA (US); John Haggis, San Jose, CA (US)

Correspondence Address: STAINBROOK & STAINBROOK, LLP, 412 AVIATION BOULEVARD, SUITE H, SANTA ROSA, CA, 95403, US

(21) Appl. No.: 11/993,366

(22) PCT Filed: Sep. 5, 2007
(86) PCT No.: PCT/US07/77666

§ 371 Date: Dec. 20, 2007

Related U.S. Application Data
(60) Provisional application No. 60/824,578, filed on Sep. 5, 2006.

(51) Int. Cl. H04B 7/005

(52) U.S. Cl. 455/42; 455/71

(57) ABSTRACT

An automatic preset following system for use with portable multimedia playback devices. The system uses RDS protocols including, at a minimum, AF and PI. Apparatus include an RDS enabled FM transmitter for use with a portable multimedia playback device, the transmitter having a user interface with buttons for presetting the transmitter to broadcast a signal at preset PM frequencies, and an RDS enabled FM receiver for automatically tuning to the different preset FM frequencies entered into the RDS enabled FM transmitter.

### BACKGROUND OF THE INVENTION

1. Technical Field

The present invention relates generally to radio transmitters, and more particularly to a method of using Radio Data System protocols to cause a radio receiver to follow a portable media player to a station preset.

2. Background Art

The Radio Data System (“RDS”) is designed to digitally enhance the use of FM broadcast-band radio in a car. Most built-in car radios currently support several information fields contained in RDS data, including alternative frequencies, enhanced other networks, regional links, program service, travel announcement and traffic programs. More expensive car stereo systems may also support traffic messages, program type, and radio text. The RDS system provides visible data content on the radio display.

Referring to FIG. 1, there is shown a key automating feature of RDS, which is a function called, “autotuning.” Autotuning is most useful on long trips where the vehicle 10 moves from an initial service area including a first commercial FM transmitter 12 broadcasting at a first frequency 14, which also broadcasts an RDS program identification code 16 (its “PI”), as well as an RDS list of alternative frequencies 18a, 18b, 18c, transmitted from sister network stations 20, 22, 24, where current program content may be found. The RDS enabled car stereo receiver in the automobile stores the program identifier and alternative frequencies in memory.

Until recently, as the signal from one station faded out and is lost when traveling out of a clear reception area, the user would manually retune the car receiver to another station in the area into which he or she is traveling. With autotuning, or “Alternate Frequencies” as the RDS feature is known on some radios, when a signal fades below a preset threshold or is lost 26, the radio receiver automatically seeks the same network content on alternative frequencies when it loses signal strength on the current station. It does this by taking advantage of the specialized RDS alternate frequencies message (an “AF”), which earlier communicated to the receiver a list of the alternative frequencies that host the network's content in the nearby geographic area. As is well known, the “AF” list is a list of frequencies of the broadcasting stations that are concurrently transmitting the same program. Thus, when the current station fades out during travel, the radio tests each of the AF stations 28 to determine whether it can receive the network content on another station at a sufficient signal strength.

The radio receiver ultimately identifies the desired network station by detecting its PI 16. The PI is a unique code that differentiates it from other stations. All the stations belonging to the network transmit the same “PI” code. When the receiver searches the different “AF” station frequencies, it also searches for the “PI” code, rejects signals transmitted at an AF frequency with a PI that does not match 30, and matches it 32 with the code from the station in the reception area it is leaving. In this way, it can verify that it remains on the same network in the event that a different station 34 having a different PI 36 is dominating a given frequency slot 18a′ (among the AF frequencies) in the current geographic location.

Because the RDS system was developed as a European telecommunications standard, much of the technological development is taught in European patents. However, numerous US patents show improved RDS transmitters, receivers, and systems. Exemplary references include:

U.S. Pat. No. 5,636,249, to Roither, which teaches a method and apparatus for phase synchronization of a bit rate clock signal generated in an RDS receiver. The digital RDS signal is demodulated on the receiver side, and both the bit rate clock signal and the RDS signal have the same bit rate. When the RDS receiver is turned on or switched over to a transmitter receiving frequency different from that received so far, a control signal is generated which causes a phase angle shift of the bit rate clock signal such that the bit rate clock signal, starting from the occurrence of the next rising edge or, alternatively, of the next falling edge of the RDS signal, which upon that occurrence is in phase synchronism with the RDS signal.

U.S. Pat. No. 5,493,709, to Duckeck, et al, discloses a radio receiver that selects incoming traffic messages with respect to their validity for the approximate location of the radio receiver. It includes a decoder. The radio receiver uses frequency data and coordinate data transmitted by the transmitters to determine its approximate location, and compares this approximate location to locations contained in the traffic messages. When there is conformity, a conformity signal serves to switch through the location-specific messages contained in the traffic messages to an audio output device.

U.S. Pat. No. 6,957,053, to Moers, teaches a method for tuning the reception of radio broadcast signals to an FM RDS transmitter using program related data and transmitter related data; and a receiver executing the method, providing a band scanning search for detecting FM RDS transmitters exceeding a predetermined reception quality level.

U.S. Pat. No. 6,032,030, to Hegeler, shows a method for storing in receiver memory the data of a received carrier frequency of a radio transmitter, and/or of the evaluation of its reception. The regional identifier is detached from the particular PI code received with the carrier frequency, and the remaining main portion of the PI code, the detached regional identifier, and the received carrier frequency are all written into empty locations, arranged in ascending order, of other carrier frequencies, if the data are not already stored.

U.S. Pat. No. 5,222,254, to Verron, et al, discloses a receiver that identifies data in accordance with RDS. The radio includes one tuner and effects the acquisition of the identification code of an alternative channel by sampling the alternative channel during periods in which the audio output of the receiver is muted. These periods are of such a short duration that they are not noticed by the listener.

U.S. Pat. No. 5,404,588 to Henze, teaches a radio receiver having a device for decoding radio data signals divided into groups each with a predetermined number of bits and containing a program identification code, and having a switchover device for switchover from a received frequency to an alternative frequency, by briefly switching over to the alternative frequency. Data samples are taken from various groups and at various times within the groups of the radio data signal that is received at the alternative frequency. The data samples are compared with a program identification code stored in memory.

U.S. Pat. No. 5,535,442, to Kishi, shows an FM tuner capable of speeding up an AF search and a PTY search. A tuning operation by the FM tuner with an RDS demodulator is continuously controlled until a tuning is decided in accordance with a tuning signal outputted from a detector or a count of an intermediate frequency. The FM tuner has an AF search designating key for designating an AF search, a PTY designating key for designating a PTY search, and a changeover unit for switching to the tuning signal for the decision of a tuning when the AF or PTY search is designated.

U.S. Pat. No. 5,572,194, to Shiota, discloses an early model RDS receiver which receives a primary FM signal, along with RDS data, and includes a tuner circuit for receiving the broadcast wave signal, a decoder circuit and a signal generation device. The decoder circuit extracts the data (such as RDS data) relating to the broadcasting station and the program from the broadcast wave signal received by the tuner circuit. The signal generation device generates a remote control signal based on the data output from the decoder circuit, and outputs the generated remote control signal. The audio device includes a receiving section for receiving the remote control signal output from the signal generation device. The operation of the audio device is controlled based on the control signal output from the signal generation device of receiving section.

The foregoing patents, each of which are incorporated by reference herein in their entirety, reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

A recent and now principal use of FM broadcast-band stereo-audio transmitters is to send audio signals from a portable media player to an automobile radio receiver for musical enjoyment while traveling. These portable consumer units transmit to a pre-selected station which is unused in the area in which the vehicle is traveling. Typically, they transmit at low power levels barely sufficient to reach the radio receiver in the same car. Furthermore, as the car travels between cities or even between areas in the same city, a frequency available in one area may become occupied by a commercial broadcaster or may receive other kinds of interference further down the road.

The evolution of consumer FM music transmitter products has seen a significant expansion of channel options; most transmitters today can be tuned across the entire FM broadcast band. This greatly enhances the ability to find unused frequencies in a local reception area. To manage all these possible frequencies, many transmitter products have preset buttons, much like the station presets on a conventional car radio. This allows direct access to a few best frequencies in the area.

The most efficient way to use station presets when broadcasting with a consumer electronic FM music transmitter connected to a portable media playback device is to program preset buttons on the car radio to match the frequencies of the preset button settings in the FM music transmitter. When such presets are made, the operator can switch to the new channel on both the transmitter and receiver when interference makes the old channel undesirable. Matching preset buttons makes the switching more convenient and increases driving safety.

### DISCLOSURE OF INVENTION

Described herein is a method and apparatus to enhance the convenience of changing stations using automatic, coordinated switching between station presets in a consumer electronic portable FM transmitter and a receiver. This method requires the operator to change the preset on the transmitter only, and the receiver will synchronize to the new transmitter frequency automatically. The method uses RDS (Radio Data System) protocols originally intended for other purposes to influence the radio receiver to follow the transmitter to a new station.

The foregoing broadly outlines the more important features of the invention in order that the detailed description that follows may be better understood, and in order that the present contribution to the art may be better appreciated. Additional objects, advantages and novel features of the invention will be set forth in part in the description as follows, and in part will become apparent to those skilled in the art upon examination of the following. Furthermore, such objects, advantages and features may be learned by practice of the invention, or may be realized and attained by means of the instrumentalities and combinations particularly pointed out in the appended claims.

Still other objects and advantages of the present invention will become readily apparent to those skilled in this art from the following detailed description, which shows and describes a preferred embodiment of the invention, simply by way of illustration of the best mode now contemplated of carrying out the invention. As will be realized, the invention is capable of modification in various obvious respects without departing from the invention. Accordingly, the drawings and description of the preferred embodiment are to be regarded as illustrative in nature, and not as restrictive.

### BRIEF DESCRIPTION OF THE DRAWINGS

FIG. 1 is a schematic view showing the PRIOR ART use of “AF mode RDS receiver.

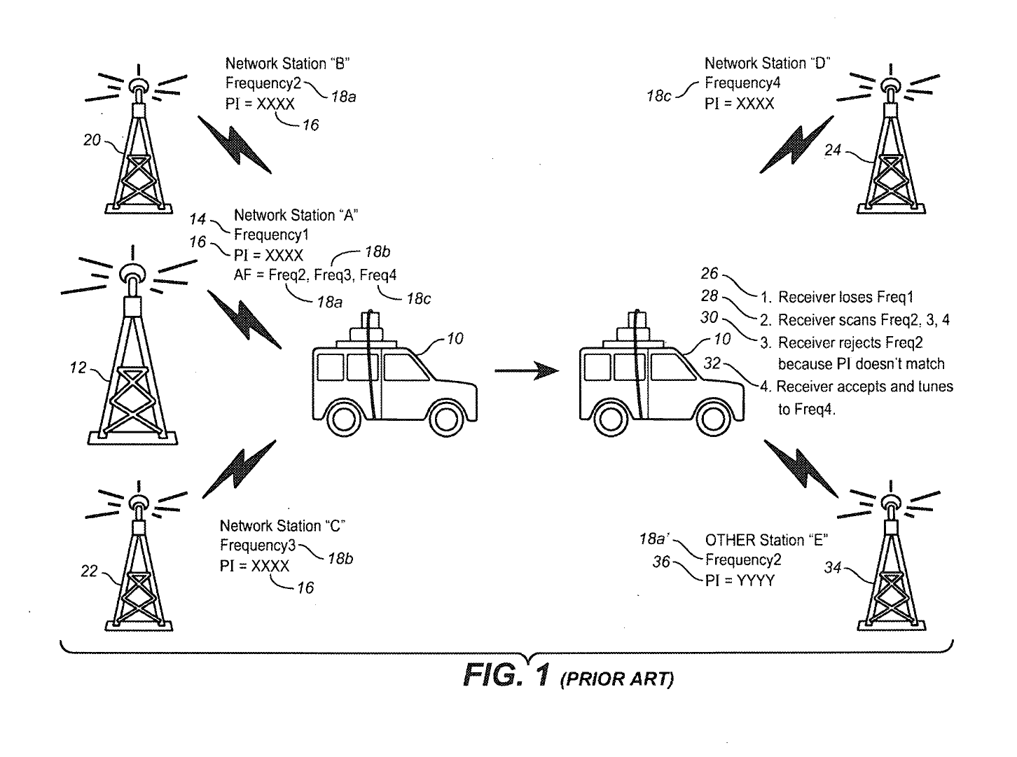

FIG. 2 is a schematic view showing a preferred embodiment of the automatic preset tuning method and apparatus of the present invention using “PI” and “AF” messages with “AF” mode RDS receiver.

### BEST MODE FOR CARRYING OUT THE INVENTION

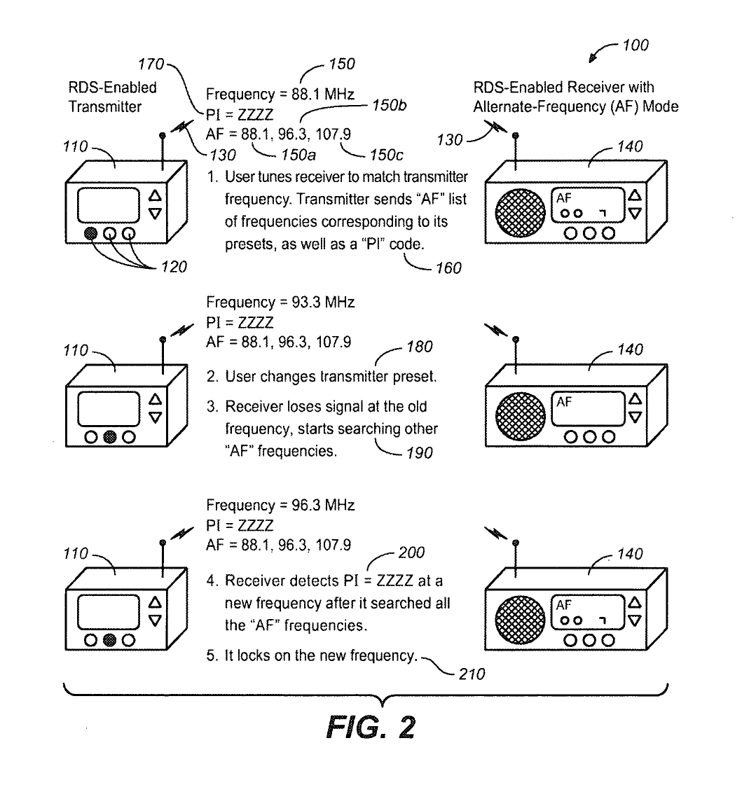

Referring now to FIG. 2, there is shown the automatic preset tuning apparatus of the present invention, as well as the method of using the same, collectively denominated 100. The system uses RDS protocols, including, at a minimum, alternative frequencies automatic tuning (“AF”), as well as the program identification code (“PI”).

The present invention includes an RDS enabled transmitter 110 with preset buttons 120 for a user to input preselected FM broadcast frequencies. The transmitter uses the RDS codes “AF” and “PI” to signal 130 an RDS-enabled receiver 140 so that the receiver will automatically tune to the different preset frequencies, or stations. This may be termed “automatic preset following.” It shall be understood that the transmitter shown schematically in FIG. 2 is principally adapted for use with consumer electronic portable multimedia playback device. As such the transmitter may be powered by a battery, by an automobile battery through a cigarette lighter adapter, or by a power supply provided for the playback device itself. Such a device is shown in International Pat. Appl. Ser. No. PCT/US06/62635, entitled, Combination battery charger, fm transmitter, transceiver, and rds generator; and International Pat. Appl. Ser. No. PCT/US06/61537, entitled, Hybrid digital digital/analog FM multiplexer/transmitter, each of which is incorporated in its entirety herein.

The inventive transmitter may transmit at an initial frequency 150 selected by the user, but has several frequency (station) presets 150a, 150b, 150c, which the user sets up through the user interface.

When the user initially tunes the receiver to match the transmitter 160, the transmitter sends, and the receiver detects, the transmitter “PI” code 170 to identify itself and an “AF” list of frequencies representing each of the presets.

When the user selects a new preset 180, the receiver searches 190 the “AF” frequencies it received earlier for a station with the same “PI”, and it finds the PI at a new frequency 200. It then locks onto the new frequency 210.

Resynchronization after Changing Presets: The transmitter regularly and constantly resends its “AF” list, so any time the user changes the frequency setting of a preset, the transmitter updates the receiver with the new setting. However, if the user manually changes the frequency in order to program a new preset, the receiver will not have received the “AF” message about the frequency of the new preset. In this case, the user will have to either manually tune the receiver to the transmitter's current frequency, or switch the transmitter to one of the old presets.

In a manual method of the present invention, after changing the receiver tuning to match the transmitter, the receiver gets the new “AF” frequency list.

Contrasting the present invention with the prior art, it should be noted that in the prior art preset method, after switching the transmitter to a prior preset, if the receiver is still searching, it automatically finds the transmitter's signal again. It then receives the new “AF” frequency list with the new preset frequency. However, attempts to use the prior art preset method to resynchronize the transmitter and receiver may not work if the receiver allocates a maximum amount of time to search for a new “AF'” station. In other words, the receiver may stop searching after a time, and if this time is shorter than the time it takes the user to reprogram the new preset and switch back to an old one, the receiver may simply remain on the old frequency or may tune itself to an entirely unplanned frequency. In this case, the user may need to revert to the “manual” method; namely, to tune the receiver to match the transmitter once to get it back in sync.

Related Methods: The same method of automatic preset following may be accomplished using RDS message data, such as the “EON” or “Enhanced Other Networks.” The EON messages also deliver a set of “AF” frequencies, which are allowed to override the current frequency at the request of an EON message or loss of signal. The receiver would switch to the specified EON-AF frequency for temporary broadcasts such as emergency alerts or traffic advisories. In typical EON operation, the receiver would switch back to the original frequency when the “announcement”ends, as signaled by another EON message. However, in applying this to automatic preset following it has been found that the receiver remains on the new station indefinitely if not requested otherwise. Thus, automatic receiver switching to match a change in the transmitter is provided in the present invention.

In either implementation, the transmitter may be enabled to send a message to the receiver any time a frequency is to be changed according to the presets. To facilitate rapid display so that a user will see the message before the frequency is actually changed, it is desirable to limit the message to a minimal length. Accordingly, the message “AutoTune” may be displayed on the receiver before it changes the frequency in the transmitter.

Having fully described the preferred embodiment of the present invention, many other equivalents and alternative embodiments will be apparent to those skilled in the art. These and other equivalents and alternatives are intended to be included within the scope of the present invention.

What is claimed as invention is:

1. An automatic preset following system using RDS protocols, comprising:
an RDS enabled FM transmitter for use with a portable multimedia playback device, said transmitter having a user interface including buttons for presetting said transmitter to broadcast a signal at preset FM frequencies for transmission of one or more signals to an FM receiver;
an RDS enabled FM receiver for automatically tuning to the different preset FM frequencies entered into said RDS enabled FM transmitter;

2. The system of claim 1, wherein the RDS codes used by said transmitter include the alternative frequencies code (“AF”) and program identification code (“PI”).

3. The system of claim 1, wherein said transmitter transmits at an initial frequency selected by a user and includes several alternative frequency presets which may be entered into transmitter memory through said user interface.

4. The system of claim 1, wherein when a user tunes said receiver to receive a signal transmitted by said by said transmitter, said transmitter sends, and the receiver detects, the transmitter PI code to identify itself as well as the AF list of frequencies representing each of the presets, and wherein when the user selects a new preset, said receiver searches the AF frequencies earlier received for a station with the same PI, finds the PI at a new frequency, and locks onto the new frequency.

5. The system of claim 1, wherein said transmitter regularly and constantly resends its AF list, such that any time the user changes the frequency setting of a preset, the transmitter updates the receiver with the new setting.

6. The system of claim 5, wherein any time a user manually changes the receiver tuning to match said transmitter, said receiver receives a new AF list from said transmitter.

7. The system of claim 1, wherein said RDS protocols include Enhanced Other Networks (“EON”).

8. A method of automatically following user preset FM frequencies broadcast from a portable RDS enabled FM transmitter connected to a portable multimedia playback device, said method comprising the steps of:
(a) providing an RDS enabled transmitter having a user interface and preset buttons, wherein the transmitter uses RDS codes, including, at a minimum, “AF” and “PI” to signal an RDS-enabled receiver;
(b) providing an RDS enabled receiver for automatically tuning to the different stations present by a user in the transmitter;
(c) manually selecting an initial FM frequency and a plurality of alternative frequency presets through the user interface and preset buttons.

9. The method of claim 8, whereby when the user initially tunes the receiver to match the transmitter, the transmitter sends, and the receiver detects, the transmitter PI code to identify itself and an AF list of frequencies representing each of the frequency presets.

10. The method of claim 8, whereby when the user selects a new preset after initially selecting alternative frequency presets, the receiver searches the AF frequencies earlier received for a station with the same PI, and when the receiver finds the PI at a new frequency, it locks onto the new frequency.

11. The method of claim 10, whereby the transmitter regularly and constantly resends its AF list.

12. The method of claim 8, whereby any time a user changes the frequency setting of a preset, the transmitter updates the receiver with the new setting.

13. The method of claim 12, whereby when a user manually changes the receiver tuning to match the transmitter broadcast signal, the transmitter sends, and the receiver receives, a new AF frequency list.

14. The method of claim 8, further including the step of providing a transmitter and receiver enabled to use the Enhanced Other Networks (“EON”) code.

15. The method of claim 14, wherein the transmitter delivers a set of AF frequencies when it sends EON messages.

16. The method of claim 15, wherein the set of AF frequencies sent with the EON message overrides a current frequency either at the request of an EON message or loss of signal.

17. The method of claim 16, wherein the receiver switches to a specified EON-AF frequency for temporary broadcasts, such as emergency alerts or traffic advisories.

18. The method of claim 17, wherein the receiver switches back to the original frequency when a temporary broadcast ends, as signaled by another EON message.
